(19) United States
(12) Patent Application Publication
(10) Pub. No.: US 2020/0042597 A1
(43) Pub. Date: Feb. 6, 2020

(54) GENERATING QUESTION-ANSWER PAIRS FOR AUTOMATED CHATTING

(71) Applicant: Microsoft Technology Licensing, LLC, Redmond, WA (US)

(72) Inventor: Xianchao Wu, Tokyo (JP)

(21) Appl. No.: 16/493,699

(22) PCT Filed: Apr. 27, 2017
(86) PCT No.: PCT/CN2017/082253

§ 371 Date: Sep. 12, 2019

(51) Int. Cl. G06F 17/27; H04L 12/58; G06F 16/332; G06F 17/28

(52) U.S. Cl. CPC G06F 17/2785; G06F 17/289; G06F 16/3329; H04L 51/02

(57) ABSTRACT

The present disclosure provides method and apparatus for generating question-answer (QA) pairs for automated chatting. A plain text may be obtained. A question may be determined based on the plain text through a deep learning model. A QA pair may be formed based on the question and the plain text.

### BACKGROUND

Artificial Intelligence (AI) chatbot is becoming more and more popular, and is being applied in an increasing number of scenarios. The chatbot is designed to simulate people's conversation, and may chat with users by text, speech, image, etc. Generally, the chatbot may scan for keywords within a message input by a user or apply natural language processing on the message, and provide a response with the most matching keywords or the most similar wording pattern to the user. The chatbot may be constructed based on a set of question-answer (QA) pairs that can facilitate the chatbot to determine the response to the message input by the user.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose method and apparatus for generating question-answer (QA) pairs for automated chatting. A plain text may be obtained. A question may be determined based on the plain text through a deep learning model. A QA pair may be formed based on the question and the plain text.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary application scenario of a chatbot according to an embodiment.

FIG. 2 illustrates an exemplary chatbot system according to an embodiment.

FIG. 3 illustrates an exemplary chat window according to an embodiment.

FIG. 4 illustrates an exemplary process for generating QA pairs according to an embodiment.

FIG. 5 illustrates an exemplary process for generating QA pairs through a Learning-to-Rank (LTR) model according to an embodiment.

FIG. 6 illustrates an exemplary matching between a plain text and a reference QA pair according to an embodiment.

FIG. 7 illustrates an exemplary process for training a recurrent neutral network which is for determining similarity scores according to an embodiment.

FIG. 8 illustrates an exemplary GRU process according to an embodiment.

FIG. 9 illustrates an exemplary process for applying a recurrent neutral network for determining similarity scores according to an embodiment.

FIG. 10 illustrates an exemplary process for generating QA pairs through a Neutral Machine Translation (NMT) model according to an embodiment.

FIG. 11 illustrates an exemplary structure of an NMT model according to an embodiment.

FIG. 12 illustrates an exemplary process for generating a question through a Dynamic Memory Network (DMN) model according to an embodiment.

FIG. 13 illustrates exemplary user interfaces according to an embodiment.

FIG. 14 illustrates a flowchart of an exemplary method for generating QA pairs for automated chatting according to an embodiment.

FIG. 15 illustrates an exemplary apparatus for generating QA pairs for automated chatting according to an embodiment.

FIG. 16 illustrates an exemplary apparatus for generating QA pairs for automated chatting according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

AI chat system, e.g., AI chatbot, is tending to be one of the most impressive directions in the AI field in recent years. Conversation, through voice, text, etc., is discovered as a unified entrance to a number of products or applications. For example, E-commerce online shopping may customize general chatbots to fit individual shops that are selling clothes, shoes, cameras, cosmetics, etc., and supply online and in-time conversation-style consumer services. Through this multiple-round conversation, consumers' questions can be answered and the consumers' orders may be expected to be received consequently. In addition, the consumers' detailed requests can be clarified step-by-step during the conversation. This type of consumer service is more user-friendly compared with traditional search engines which are designed for a single-round question-answering service. On the other hand, search engines can be further taken as a background “toolkit” to help making the chatbot's responses to be more accurate and more diverse.

Conventional methods for constructing chatbot may obtain a set of QA pairs from QA style websites, e.g., Yahoo Answers. Lineq, Zhihu, etc., and use the set of QA pairs to construct a chatbot. However, since these conventional methods lack effective technical means for obtaining QA pairs from a large-scale of plain texts automatically, they are limited to use QA pairs from the QA style websites to construct the chatbot. In other words, these conventional methods cannot construct a chatbot based on plain texts automatically and effectively. Accordingly, it is difficult for these conventional methods to construct chatbots for a lot of domains or companies, since these domains or companies only have a number of plain texts but have no QA pairs. Herein, plain texts may refer to non-QA-style texts, such as, product descriptions, user comments, etc. A plain text may contain one single sentence or a plurality of sentences.

Embodiments of the present disclosure propose to generate QA pairs from plain texts automatically. Accordingly, chatbots may also be constructed based on the plain texts. Deep learning techniques in conjunction with natural language processing techniques may be adopted in the embodiments. For example, the embodiments may determine a question based on a plain text through the deep learning techniques, and further form a QA pair based on the question and the plain text. In this way, a set of QA pairs may be generated from a plurality of plain texts. The deep learning techniques may comprise Learning-to-Rank (LTR) algorithm. Neutral Machine Translation (NMT) technique, Dynamic Memory Network (DMN) technique, etc.

According to the embodiments of the present disclosure, a chatbot may be constructed for a specific domain or for a specific company, as long as plain texts of this domain or company are given. The deep learning techniques may help extracting rich information included in plain texts. Consequently, questions can be built for the “rich information”. Through constructing chatbots based on a large-scale of plain texts, knowledge from various domains can be used for enriching responses provided by the chatbots.

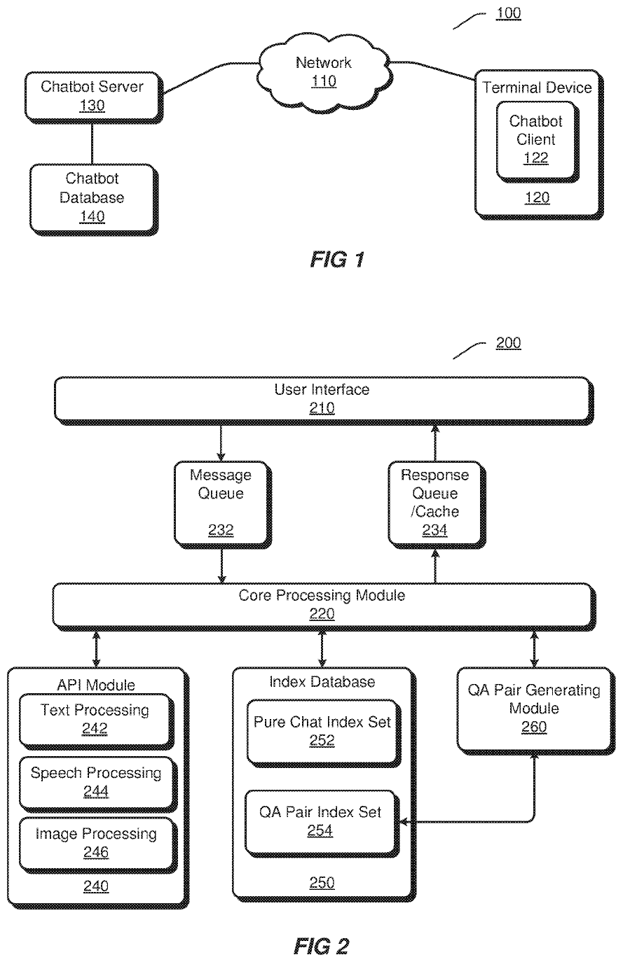

FIG. 1 illustrates an exemplary application scenario 100 of a chatbot according to an embodiment.

In FIG. 1, a network 110 is applied for interconnecting among a terminal device 120 and a chatbot server 130.

The network 110 may be any type of networks capable of interconnecting network entities. The network 110 may be a single network or a combination of various networks. In terms of coverage range, the network 110 may be a Local Area Network (LAN), a Wide Area Network (WAN), etc. In terms of carrying medium, the network 110 may be a wireline network, a wireless network, etc. In terms of data switching techniques, the network 110 may be a circuit switching network, a packet switching network, etc.

The terminal device 120 may be any type of electronic computing devices capable of connecting to the network 110, assessing servers or websites on the network 110, processing data or signals, etc. For example, the terminal device 120 may be a desktop computer, a laptop, a tablet, a smart phone, etc. Although only one terminal device 120 is shown in FIG. 1, it should be appreciated that a different number of terminal devices may connect to the network 110.

The terminal device 120 may include a chatbot client 122 which may provide automated chatting service for a user. In some implementations, the chatbot client 122 may interact with the chatbot server 130. For example, the chatbot client 122 may transmit messages input by the user to the chatbot server 130, and receive responses associated with the messages from the chatbot server 130. However, it should be appreciated that, in other implementations, instead of interacting with the chatbot server 130, the chatbot client 122 may also locally generate responses to messages input by the user.

The chatbot server 130 may connect to or incorporate a chatbot database 140. The chatbot database 140 may comprise information that can be used by the chatbot server 130 for generating responses.

It should be appreciated that all the network entities shown in FIG. 1 are exemplary, and depending on specific application requirements, any other network entities may be involved in the application scenario 100.

FIG. 2 illustrates an exemplary chatbot system 200 according to an embodiment.

The chatbot system 200 may comprise a user interface (UI) 210 for presenting a chat window. The chat window may be used by the chatbot for interacting with a user.

The chatbot system 200 may comprise a core processing module 220. The core processing module 220 is configured for, during operation of the chatbot, providing processing capabilities through cooperation with other modules of the chatbot system 200.

The core processing module 220 may obtain messages input by the user in the chat window, and store the messages in the message queue 232. The messages may be in various multimedia forms, such as, text, speech, image, video, etc.

The core processing module 220 may process the messages in the message queue 232 in a first-in-first-out manner. The core processing module 220 may invoke processing units in an application program interface (API) module 240 for processing various forms of messages. The API module 240 may comprise a text processing unit 242, a speech processing unit 244, an image processing unit 246, etc.

For a text message, the text processing unit 242 may perform text understanding on the text message, and the core processing module 220 may further determine a text response.

For a speech message, the speech processing unit 244 may perform a speech-to-text conversion on the speech message to obtain text sentences, the text processing unit 242 may perform text understanding on the obtained text sentences, and the core processing module 220 may further determine a text response. If it is determined to provide a response in speech, the speech processing unit 244 may perform a text-to-speech conversion on the text response to generate a corresponding speech response.

For an image message, the image processing unit 246 may perform image recognition on the image message to generate corresponding texts, and the core processing module 220 may further determine a text response. In some cases, the image processing unit 246 may also be used for obtaining an image response based on the text response.

Moreover, although not shown in FIG. 2, the API module 240 may also comprise any other processing units. For example, the API module 240 may comprise a video processing unit for cooperating with the core processing module 220 to process a video message and determine a response.

The core processing module 220 may determine responses through an index database 250. The index database 250 may comprise a plurality of index items that can be retrieved by the core processing module 220 as responses. The index items in the index database 250 may be classified into a pure chat index set 252 and a QA pair index set 254. The pure chat index set 252 may comprise index items that are prepared for free chatting between users and the chatbot, and may be established with data from social networks. The index items in the pure chat index set 252 may or may not be in a form of question-answer pair. A question-answer pair may also be referred to as message-response pair. The QA pair index set 254 may comprise QA pairs generated based on plain texts through methods according to the embodiments of the present disclosure.

The chatbot system 200 may comprise a QA pair generating module 260. The QA pair generating module 260 may be used for generating QA pairs based on plain texts according to the embodiments of the present disclosure. The generated QA pairs may be indexed in the QA pair index set 254

The responses determined by the core processing module 220 may be provided to a response queue or response cache 234. For example, the response cache 234 may ensure that a sequence of responses can be displayed in a pre-defined time stream. Assuming that, for a message, there are no less than two responses determined by the core processing module 220, then a time-delay setting for the responses may be necessary. For example, if a message input by the player is “Did you eat your breakfast?”, two responses may be determined, such as, a first response “Yes, I ate bread” and a second response “How about you? Still feeling hungry?”. In this case, through the response cache 234, the chatbot may ensure that the first response is provided to the player immediately. Further, the chatbot may ensure that the second response is provided in a time delay, such as 1 or 2 seconds, so that the second response will be provided to the player 1 or 2 seconds after the first response. As such, the response cache 234 may manage the to-be-sent responses and appropriate timing for each response.

The responses in the response queue or response cache 234 may be further transferred to the user interface 210 such that the responses can be displayed to the user in the chat window.

It should be appreciated that all the elements shown in the chatbot system 200 in FIG. 2 are exemplary, and depending on specific application requirements, any shown elements may be omitted and any other elements may be involved in the chatbot system 200.

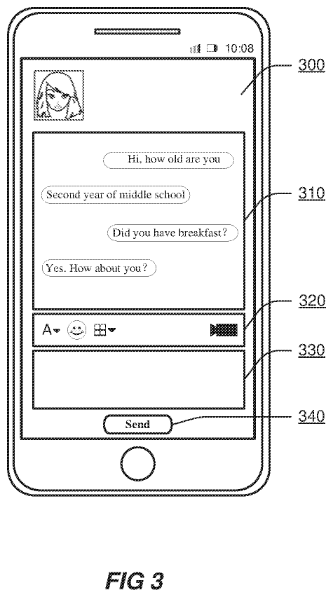

FIG. 3 illustrates an exemplary chat window 300 according to an embodiment. The chat window 300 may comprise a presentation area 310, a control area 320 and an input area 330. The presentation area 310 displays messages and responses in a chat flow. The control area 320 includes a plurality of virtual buttons for the user to perform message input settings. For example, the user may select to make a voice input, attach image files, select emoji symbols, make a short-cut of the current screen, etc. through the control area 320. The input area 330 is used for the user to input messages. For example, the user may type text through the input area 330. The chat window 300 may further comprise a virtual button 340 for confirming to send input messages. If the user touches the virtual button 340, the messages input in the input area 330 may be sent to the presentation area 310.

It should be noted that all the elements and their layout shown in FIG. 3 are exemplary. Depending on specific application requirements, the chat window in FIG. 3 may omit or add any elements, and the layout of the elements in the chat window in FIG. 3 may also be changed in various manners.

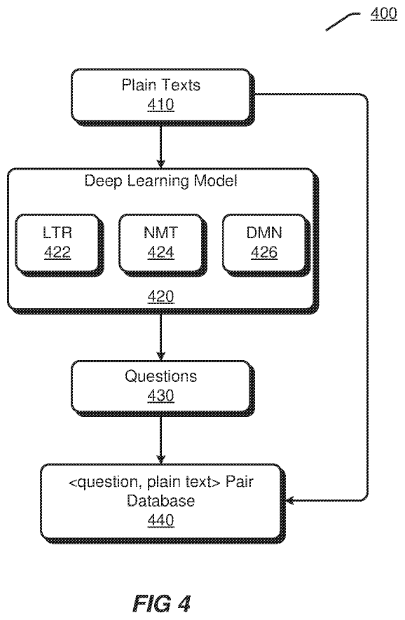

FIG. 4 illustrates an exemplary process 400 for generating QA pairs according to an embodiment. The process 400 may be performed by, such as, the QA pair generating model 260 shown in FIG. 2.

A plurality of plain texts 410 may be obtained. The plain texts 410 may be crawled from a website of a content source, e.g., a company. The plain texts 410 may also be received in plain text documents provided by the content source. In some implementations, the plain texts 410 are relating to a specific domain or a specific company for which a chatbot is desired to be constructed.

The plain texts 410 may be provided to a deep learning model 420. The deep learning model 420 may determine questions 430 based on the plain texts 410. Various techniques may be adopted in the deep learning model 420. For example, the deep learning model 420 may comprise at least one of a LTR model 422, a NMT model 424 and a DMN model 426. Any one or any combination of the LTR model 422, the NMT model 424 and the DMN model 426 may be used for generating questions 430 based on the plain texts 410.

The LTR model 422 may find questions for a plain text from a reference QA database. The reference QA database may comprise a plurality of reference <question, answer> QA pairs. A reference QA pair may also be referred to as an existing QA pair, which is obtained from QA websites or through any known approaches. A ranking algorithm in the LTR model 422 may take a plain text and reference QA pairs in the reference QA database as inputs, and compute similarity scores between the plain text and each reference QA pair through at least one of word matching and latent semantic matching. For example, the ranking algorithm may compute a first matching score between the plain text and a reference question in each reference QA pair and a second matching score between the plain text and a reference answer in the reference QA pair, and then obtain a similarity score of the reference QA pair based on the first matching score and the second matching score. In this way, the ranking algorithm may obtain a set of similarity scores of reference QA pairs in the reference QA database compared to the plain text, and then rank the reference QA pairs based on the similarity scores. A reference question in a top-ranked reference QA pair may be selected as a question for the plain text.

The NMT model 424 may generate a question based on a plain text in a sequence-to-sequence approach. For example, if the plain text is provided to the NMT model 424 as an input, then the question may be output by the NMT model 424. In other words, the plain text may be translated by the NMT model 424 into the question directly.

The DMN model 426 may generate a question based on a plain text through capturing latent semantic relations in the plain text. That is, the DMN model 426 may reason out the question for a list of sentences in the plain text automatically. For example, the DMN model 426 may capture latent semantic relations among the list of sentences in the plain text automatically to determine whether to use or ignore a sentence or words in a sentence during generating the question. In an implementation, the DMN model 426 may take a result from the NMT model 424 as a priori input, so as to further improve quality of the question finally generated. It should be appreciated that the NMT model 424 may provide a local optimization, while the DMN model 426 may provide a global optimization since it is strong at multi-turn “reasoning”. Moreover, in an implementation, the DMN model 426 may also use one or more candidate questions generated by the LTR model 422 to further improve quality of the question finally generated.

Upon determining questions for plain texts through the deep learning model 420, a plurality of QA pairs may be formed and added into a <question, plain text> pair database 440. For example, for a plain text, a QA pair may be formed based on the plain text and a question determined for the plain text, where the plain text is added in an answer part of the QA pair. The <question, plain text> pair database 440 may be further used for establishing the QA pair index set 254 shown in FIG. 2.

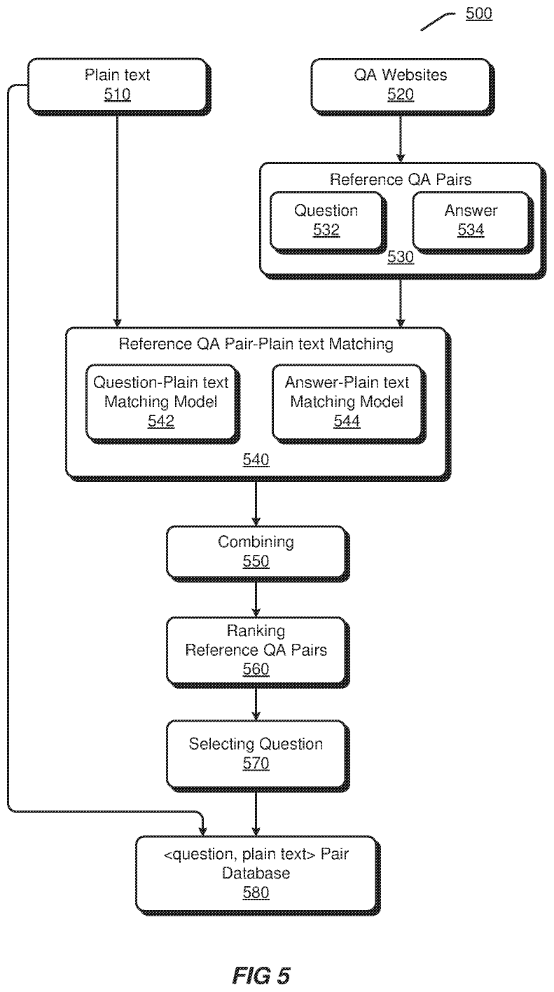

FIG. 5 illustrates an exemplary process 500 for generating QA pairs through a LTR model according to an embodiment.

The process 500 may be performed for generating QA pairs for a plain text 510.

According to the process 500, a plurality of QA pairs may be obtained from QA websites 520. The QA websites 520 may be any QA style websites, e.g., Yahoo Answers, Lineq, Zhihu, etc.

The QA pairs obtained from the QA websites 520 may be used as reference QA pairs 530. Each reference QA pair may contain a reference question 532 and a reference answer 534.

At 540, a reference QA pair-plain text matching may be applied on the plain text 510 and the reference QA pairs 530. The reference QA pair-plain text matching at 540 may perform a matching process between the plain text 510 and the reference QA pairs 530 through, such as, word matching and/or latent semantic matching. The word matching may refer to a character, word or phrase level comparison between a plain text and a reference QA pair so as to find shared/matched words. The latent semantic matching may refer to a comparison in a dense vector space between a plain text and a reference QA pair so as to find semantically related words. It should be appreciated that, in this disclosure, the use of the terms “word”, “character” and “phrase” may be interchanged among each other. For example, if the term “word” is used in an expression, this term may also be interpreted as “character” or “phrase”.

In an implementation, a question-plain text matching model 542 and an answer-plain text matching model 544 may be adopted in the reference QA pair-plain text matching 540. The question-plain text matching model 542 may compute a matching score, S(question, plain text), between the plain text 510 and a reference question in a reference QA pair. The answer-plain text matching model 544 may compute a matching score, S(answer, plain text), between the plain text 510 and a reference answer in the reference QA pair. The question-plain text matching model 542 and the answer-plain text matching model 544 will be further discussed later.

At 550, the matching score obtained by the question-plain text matching model 542 and the matching score obtained by the answer-plain text matching model 544 may be combined so as to obtain a similarity score, S (<question, answer>, plain text), for the reference QA pair. The similarity score may be computed through:

S(<question,answer>,plain text)=λ*S(question,plain text)+(1−λ)*S(answer,plain text) Equation (1)

where λ is a hyper-parameter and λ∈[0, 1].

Through performing the reference QA pair-plain text matching at 540 and the combining at 500 for each of the reference QA pairs 530, similarity scores of these reference QA pairs 530 compared to the plain text 510 may be obtained respectively. Thus, these reference QA pairs 530 may be ranked at 560 based on the similarity scores.

At 570, a reference question in a top-ranked reference QA pair may be selected as a question for the plain text 510.

A <question, plain text> pair may be formed based on the selected question and the plain text 510, and added into a <question, plain text> pair database 580. Question-plain text pairs in the <question, plain text> pair database 580 may be construed as QA pairs generated through the LTR model according to the embodiments of the present disclosure.

It should be appreciated that, in some implementations, more than one question-plain text may be generated for the plain text 510. For example, at 570, two or more reference questions in two or more top-ranked reference QA pairs may be selected as questions for the plain text 510, and thus two or more question-plain text pairs may be formed based on the selected questions and the plain text 510.

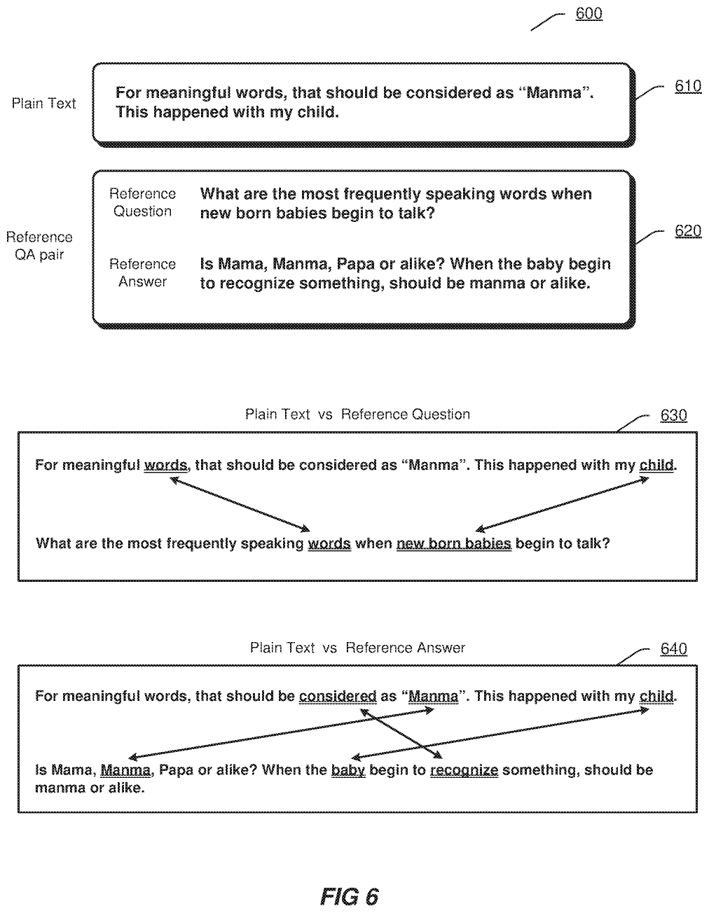

FIG. 6 illustrates an exemplary matching 600 between a plain text and a reference QA pair according to an embodiment. The matching 600 may be implemented by the reference QA pair-plain text matching 540 shown in FIG. 5.

An exemplary plain text 610 may be: For meaningful words, that should be considered as “Manma”. This happened with my child. An exemplary reference QA pair 620 may comprise a reference question and a reference answer. The reference question may be: What are the most frequently speaking words when new born babies begin to talk? The reference answer may be: Is Mama, Manma, Papa or alike? When the baby begin to recognize something, should be manma or alike.

Block 630 shows an exemplary matching between the plain text 610 and the reference question in the reference QA pair 620. For example, the term “words” in the plain text 610 is found matching the term “words” in the reference question, and the term “child” in the plain text 610 is found latent-semantically matching the phrase “new born babies” in the reference question.

Block 640 shows an exemplary matching between the plain text 610 and the reference answer in the reference QA pair 620. For example, the term “Manma” in the plain text 610 is found matching the term “Manma” in the reference answer, the term “considered” in the plain text 610 is found latent-semantically matching the term “recognize” in the reference answer, and the term “child” in the plain text 610 is found latent-semantically matching the term “baby” in the reference answer.

Next, the question-plain text matching model 542 shown in FIG. 5 will be discussed in details.

A Gradient Boosting Decision Tree (GBDT) may be adopted for the question-plain text matching model 542. The GBDT may take a plain text and reference questions in a plurality of reference QA pairs as inputs, and output similarity scores of the reference questions compared to the plain text.

In an implementation, a feature in the GBDT may be based on a language model for information retrieval. This feature may evaluate relevance between a plain text q and a reference question Q through:

P(q|Q)=Π_{w∈q}[(1−λ)Pₘₗ(w|Q)+λPₘₗ(w|C)] Equation (2)

where Pₘₗ(w|Q) is the maximum likelihood of word w estimated from Q, and Pₘₗ(w|C) is a smoothing item that is computed as the maximum likelihood estimation in a large-scale corpus C. The smoothing item avoids zero probability, which stems from those words appearing in the plain text q but not in the reference question Q. λ is a parameter that acts as a trade-off between the likelihood and the smoothing item, where λ∈[0, 1]. This feature works well when there are a number of words overlapped between the plain text and the reference question.

In an implementation, a feature in the GBDT may be based on a translation-based language model. This feature may learn word-to-word and/or phrase-to-phrase translation probability from, such as, reference questions or reference QA pairs, and may incorporate the learned information into the maximum likelihood. Given a plain text q and a reference question Q, the translation-based language model may be defined as:

P_{trb}(q|Q)=└_{w∈q}[(1−λ)Pₘₓ(w|Q)+λPₘₗ(w|C)] Equation (3)

where

Pₘₓ(w|Q)=αPₘₗ(w|Q)+βPₜᵣ(w|Q) Equation (4)

Pₜᵣ(w|Q)=Σ_{v∈Q}Pₜₚ(w|v)Pₘₗ(v|Q) Equation (5)

Here λ, α and β are parameters satisfying λ∈[0, 1] and α+β=1. Pₜₚ(w|v) is a translation probability from word v in Q to word w in q. Pₜᵣ(.), Pₘₓ(.) and P_{trb}(.) are similarity functions constructed step-by-step by using Pₜₚ(.) and Pₘₗ(.).

In an implementation, a feature in the GBDT may be an edit distance between a plain text and a reference question in a word or character level.

In an implementation, a feature in the GBDT may be a maximum subsequence ratio between a plain text and a reference question.

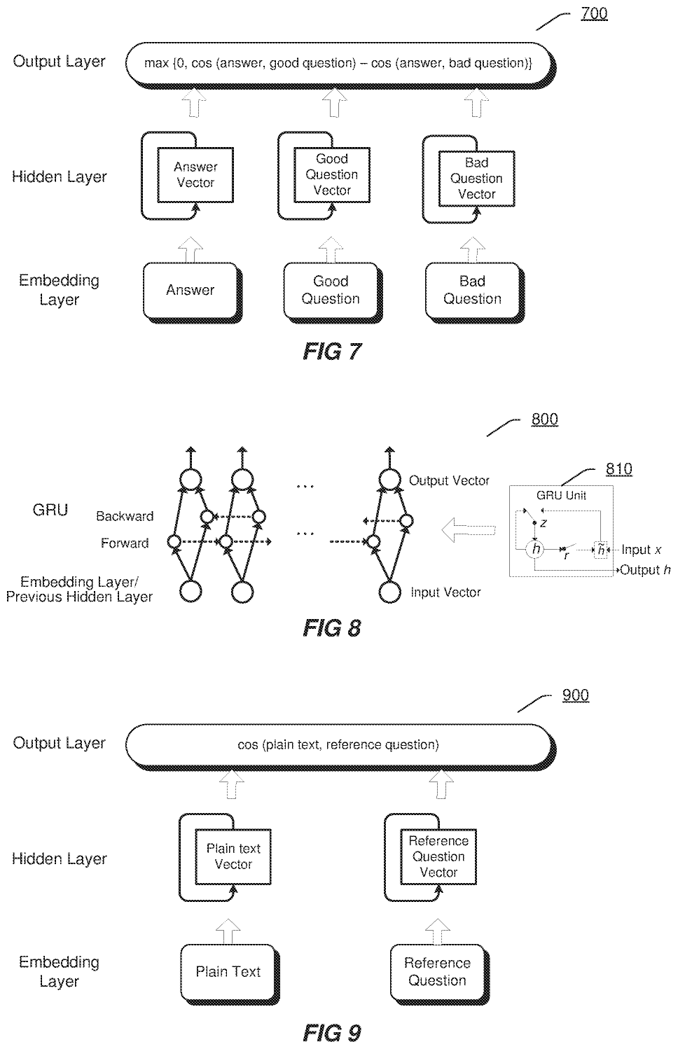

In an implementation, a feature in the GBDT may be a cosine similarity score from a recurrent neural network containing Gated Recurrent Units (GRUs). The cosine similarity score may be an evaluation for similarity between a plain text and a reference question. The recurrent neural network will be discussed in connection with FIG. 7 to FIG. 9 below.

FIG. 7 illustrates an exemplary process 700 for training a recurrent neutral network which is for determining similarity scores according to an embodiment.

Training data may be input in an embedding layer. The training data may comprise an answer, a good question and a bad question. The good question may be semantically related to the answer, while the bad question may be not semantically related to the answer. Assuming that an answer is “For meaningful words, that should be considered as ‘Manma’. This happened with my child”, then a good question may be “What are the most frequently speaking words when new born babies begin to talk?”, and a bad question may be “What is the difference between the languages of children and adults?”. The embedding layer may map the input training data into respective dense vector representations.

A hidden layer may use GRU to process the vectors from the embedding layer, e.g., vector of the answer, vector of the good question and vector of the bad question. It should be appreciated that there may be one or more hidden layers in the recurrent neural network. Here, the hidden layer may also be referred to as a recurrent hidden layer.

An output layer may compute a margin between similarity of <answer, good question> and similarity of <answer, bad question>, and maximize the margin. If the similarity of <answer, good question> is below the similarity of <answer, bad question>, a distance between these two types of similarity may be taken as an error and back propagated to the hidden layer and the embedding layer. In an implementation, the process in the output layer may be expressed as:

max{0,cos(answer,good question)−cos(answer,bad question)} Equation (6)

where cos(answer, good question) denotes a cosine similarity score between the answer and the good question, and cos(answer, bad question) denotes a cosine similarity score between the answer and the bad question.

FIG. 8 illustrates an exemplary GRU process 800 according to an embodiment. The GRU process 800 may be implemented in the hidden layer shown in FIG. 7.

An input vector for the GRU process may be obtained from an embedding layer or a previous hidden layer. The input vector may also be referred to as input sequence, word sequence, etc.

The GRU process is a type of bidirectional encoding process applied on the input vector. There are two directions in the GRU process, e.g., a left-to-right forward direction and a right-to-left backward direction. The GRU process may involves a plurality of GRU units which take an input vector x and a previous step vector hₜ₋₁ as inputs and output a next step vector hₜ.

Internal mechanism of the GRU process may be defined by the following equations:

zₜ=σ_{g}(W^{(z)}xₜ+U^{(z)}hₜ₋₁+b^{(z)}) Equation (7)

rₜ=σ_{g}(W^{(r)}xₜ+U^{(r)}hₜ₋₁+b^{(r)}) Equation (8)

\tilde{h}ₜ=σₕ(W^{(h)}xₜ+U^{(h)}(rₜ^{o}hₜ₋₁)+b^{(h)}) Equation (9)

hₜ=zₜ^{o}hₜ₋₁+(1−zₜ)^{o}\tilde{h}ₜ Equation (10)

where xₜ is an input vector, hₜ is an output vector, zₜ is an update gate vector, rₜ is a reset gate vector. σ_{g} is from a sigmoid function, σₕ is from a hyperbolic function, σ is an element-wise product, and h₀=0. Moreover, W^{(z)}, W^{(r)}, W^{(h)}, U^{(z)}, U^{(r)}, U^{(h)} are parameter matrices, and b^{(z)}, b^{(r)}, b^{(h)} are parameter vectors. Here, W^{(z)}, W^{(r)}, W^{(h)} ∈Rⁿ^{_{H}}^{×x}^{ₙ}, and U^{(z)}, U^{(r)}, U^{(h)} ∈Rⁿ^{_{H}}^{×n}^{_{H}}, n_{H} denoting a dimension of a hidden layer, and n_{I} denoting a dimension of the input vector. For example, in Equation (7), W^{(z)} is a matrix that projects the input vector xₜ into a vector space. U^{(z)} is a matrix that projects the recurrent hidden layer hₜ₋₁ into a vector space, and b^{(z)} is a bias vector that determines a relative position of the target vector zₜ. Similarly, in Equations (8) and (9), W^{(r)}, U^{(r)}, b^{(r)} and W^{(h)}, U^{(h)}, b^{(h)} function in the same way as W^{(z)}, U^{(z)} and b^{(z)}.

Block 810 in FIG. 8 shows an exemplary detailed structure of a GRU unit, where x is an input vector for the GRU unit, and h is an output vector for the GRU unit. The GRU unit may be expressed as:

hₜ^{j}=zₜ^{j}hₜ₋₁^{j}+(1−zₜ^{j})\tilde{h}ₜ^{j} Equation (11)

where j is a word index in the input vector x. Processes in both the left-to-right forward direction and the right-to-left backward direction may follow Equation (11).

FIG. 9 illustrates an exemplary process 900 for applying a recurrent neutral network for determining similarity scores according to an embodiment. The recurrent neutral network may have been trained through the process 700 shown in FIG. 7.

A plain text and a reference question may be input in an embedding layer. The embedding layer may map the input plain text and reference question into respective dense vector representations.

A hidden layer may use GRU to process the vectors from the embedding layer. i.e., vector of the plain text and vector of the reference question. It should be appreciated that there may be one or more hidden layers in the recurrent neural network.

An output layer may compute and output a cosine similarity score between the plain text and the reference question, e.g., cos (plain text, reference question). The cosine similarity score may be used as a feature in the GBDT for the question-plain text matching model 542.

Next, the answer-plain text matching model 544 shown in FIG. 5 will be discussed in details.

A GBDT may be adopted for the answer-plain text matching model 544. The GBDT may compute a similarity score of a reference answer in a plurality of reference QA pairs compared to a plain text.

In an implementation, a feature in the GBDT may be based on an edit distance in a word level between a plain text and a reference answer.

In an implementation, a feature in the GBDT may be based on an edit distance in a character level between a plain text and a reference answer. For example, for Asian languages such as Chinese and Japanese, similarity computation may be on a character basis.

In an implementation, a feature in the GBDT may be based on an accumulated Word2vec similarity score, such as a cosine similarity score, between a plain text and a reference answer. Generally, Word2vec similarity computation may project words into a dense vector space and then compute a semantic distance between two words through applying cosine function on two vectors corresponding to the two words. The Word2vec similarity computation may alleviate a sparseness problem caused by word matching. In some implementations, before computing a Word2vec similarity score, a high frequency phrase table may be used for pre-processing the plain text and the reference answer, e.g., pre-combining high frequency n-grams words in the plain text and the reference answer. The following Equations (12) and (13) may be adopted in the computing of the Word2vec similarity score.

Sim₁=Σ_{w in plain text}(Word2vec(w,vₓ)) Equation (12)

where vₓ is a word or phrase in the reference answer and makes Word2vec(w, v) the maximum among all words or phrases v in the reference answer.

Sim₂=Σ_{v in reference answer}(Word2vec(wₓ,v)) Equation (13)

where wₓ is a word or phrase in the plain text and makes Word2vec(w, v) the maximum among all words or phrases w in the plain text.

In an implementation, a feature in the GBDT may be based on a BM25 score between a plain text and a reference answer. BM25 score is a frequently used similarity score in information retrieval. BM25 may be a bag-of-words retrieval function, and may be used here for ranking a set of reference answers based on plain text words appearing in each reference answer, regardless of inter-relationship. e.g., relative proximity, between plain text words within a reference answer. BM25 may be not a single function, and may actually comprise a group of scoring functions with respective components and parameters. An exemplary function is given as follows.

For a plain text Q containing keywords q₁, . . . , qₙ, a BM25 score of a reference answer D may be:

$$Score ( D , Q ) = {\sum }_{i = 1}^{n} IDF ( {q}_{i} ) \cdot \frac{f ( {q}_{i} , D ) \cdot ( {k}_{1} + 1 )}{f ( {q}_{i} , D ) + {k}_{1} \cdot ( 1 - b + b \cdot \frac{\vert D \vert}{avgdl} )} \qquad Equation ( 14 )$$

### Here,

f(qᵢ, D) is a term frequency of word qᵢ in the reference answer D, where f(qᵢ, D)=n if qᵢ occurs n (n≥1) times in D, or otherwise f (qᵢ, D)=0;
   |D| is the number of words in the reference answer D;
avgdl is an average length of reference answers in a reference answer set M (D ∈M);
k₁ and b are free parameters, such as, k₁=1.2 and b=0.75;
IDF(qᵢ) is an inverse document frequency (IDF) weight of plain text word qᵢ. IDF(qᵢ,M)=log(N/|d∈M and qᵢ ∈d|), where N is the total number of reference answers in the reference answer set M. e.g., N=|M|. Moreover. |d∈M and qᵢ ∈d| is the number of reference answers where the word qᵢ appears.

Through Equation (14), a BM25 score of a reference answer may be computed based on a plain text.

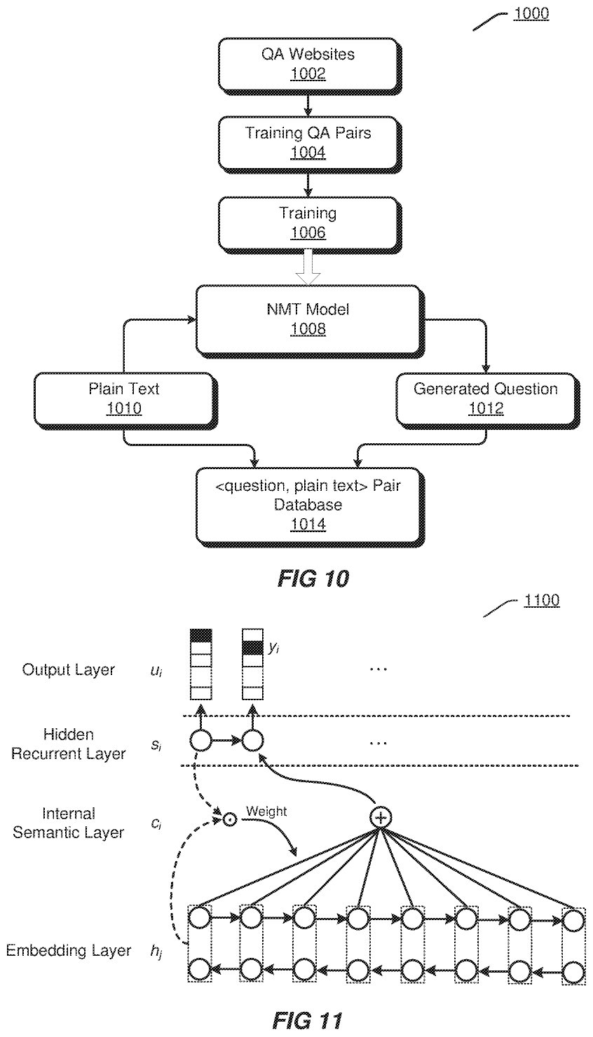

FIG. 10 illustrates an exemplary process 1000 for generating QA pairs through a NMT model according to an embodiment.

According to the process 1000, a plurality of QA pairs may be obtained from QA websites 1002. The QA websites 1002 may be any QA style websites, e.g., Yahoo Answers, Lineq. Zhihu, etc.

The QA pairs obtained from the QA websites 520 may be used as training QA pairs 1004. Each training QA pair may contain a question and an answer.

At 1006, the training QA pairs 1004 may be used for training a NMT model 1008. The NMT model 1008 may be configured for generating a question based on an input answer in a sequence-to-sequence approach. In other words, the input answer may be translated by the NMT model 1008 into the output question directly. Thus, each of the training QA pairs 1004 may be used as a pair of training data for training the NMT model 1008. An exemplary structure of the NMT model 1008 will be discussed later in connection with FIG. 11.

After the NMT model 1008 is trained, the NMT model 1008 may be used for generating questions for plain texts. For example, if a plain text 1010 is input into the NMT model 1008, the NMT model 1008 may output a generated question 1012 corresponding to the plain text 1010.

A <question, plain text> pair may be formed based on the generated question 1012 and the plain text 1010, and added into a <question, plain text> pair database 1014. Question-plain text pairs in the <question, plain text> pair database 1014 may be construed as QA pairs generated through the NMT model 1008 according to the embodiments of the present disclosure.

FIG. 11 illustrates an exemplary structure 1100 of an NMT model according to an embodiment. The NMT model may comprise an embedding layer, an internal semantic layer, a hidden recurrent layer, and an output layer.

At the embedding layer, bidirectional recurrent operations may be applied on an input sequence, such as, a plain text, so as to obtain source vectors. There are two directions involved in the bidirectional recurrent operations, e.g., left-to-right and right-to-left. In an implementation, the bidirectional recurrent operations may be based on a GRU process and follow Equations (7)-(10). The embedding layer may also be referred to as “encoder” layer. The source vectors may be denoted by temporal annotation hⱼ, where j=1, 2, . . . , Tₓ, and Tₓ is the length of the input sequence, e.g., the number of words in the input sequence.

At the internal semantic layer, an attention mechanism may be implemented. A context vector c may be computed based on a set of temporal annotations hⱼ and may be taken as a temporal dense representation of the current input sequence. The context vector cᵢ may be computed as a weighted sum of the temporal annotations hⱼ as follows:

cᵢ=Σⱼ₌₁^{T}^{ₓ})αᵢⱼhⱼ Equation (15)

The weight αᵢⱼ for each hi may also be referred to as “attention” weight, and may be computed by a softmax function:

$${α}_{i , j} = \frac{exp ( {e}_{ij} )}{{\sum }_{k = 1}^{{T}_{x}} exp ( {e}_{ik} )} \qquad Equation ( 16 )$$

where eᵢⱼ=a(sᵢ₋₁, hⱼ) is an alignment model which scores how well inputs around a position j and an output at position i match with each other. The alignment score is between a pervious hidden state sᵢ₋₁ and the j-th temporal annotation hⱼ of the input sequence. The probability αᵢⱼ reflects importance of hⱼ with respect to the previous hidden state sᵢ₋₁ in deciding the next hidden state sᵢ and simultaneously generating the next word yᵢ. The internal semantic layer implements an attention mechanism through applying the weight αᵢⱼ.

At the hidden recurrent layer, hidden states sᵢ for an output sequence are determined through a unidirectional recurrent operation, such as, a left-to-right GRU process. The computation of sᵢ also follows Equations (7)-(10).

At the output layer, word prediction for the next word yᵢ may be determined as follows:

p(yᵢ|y₁, . . . ,yᵢ₋₁,x)=g(yᵢ₋₁,sᵢ,cᵢ) Equation (17)

where sᵢ is from the hidden recurrent layer, cᵢ is from the internal semantic layer. Here, g(.) function is a nonlinear, potentially multi-layered function that outputs probabilities of the next candidate words in the output sequence. The output layer may also be referred to as a “decoder” layer.

Through the above exemplary structure, the NMT model may generate a question for a plain text through picking up “information-rich” words and changing the words into interrogative words. Through implementing the attention mechanism in the internal semantic layer, relations between an “information-rich” word and corresponding interrogative words may be captured. In other words, the attention mechanism in the NMT model may be used for determining a pattern of a question, e.g., which word in the plain text may be set a question and what interrogative word may be used in the question. Taking the sentences shown in FIG. 6 as an example, the interrogative word “what” may be determined as relating to the word “Manma” in an answer. Moreover, it should be appreciated that it may be meaningless if only these two words are considered. Thus, the NMT model may apply recurrent operations on the input sequence in the embedding layer and/or on the output sequence in the hidden recurrent layer, such that context information for each word in the input sequence and/or for each word in the output sequence may be obtained and applied during determining the output sequence.

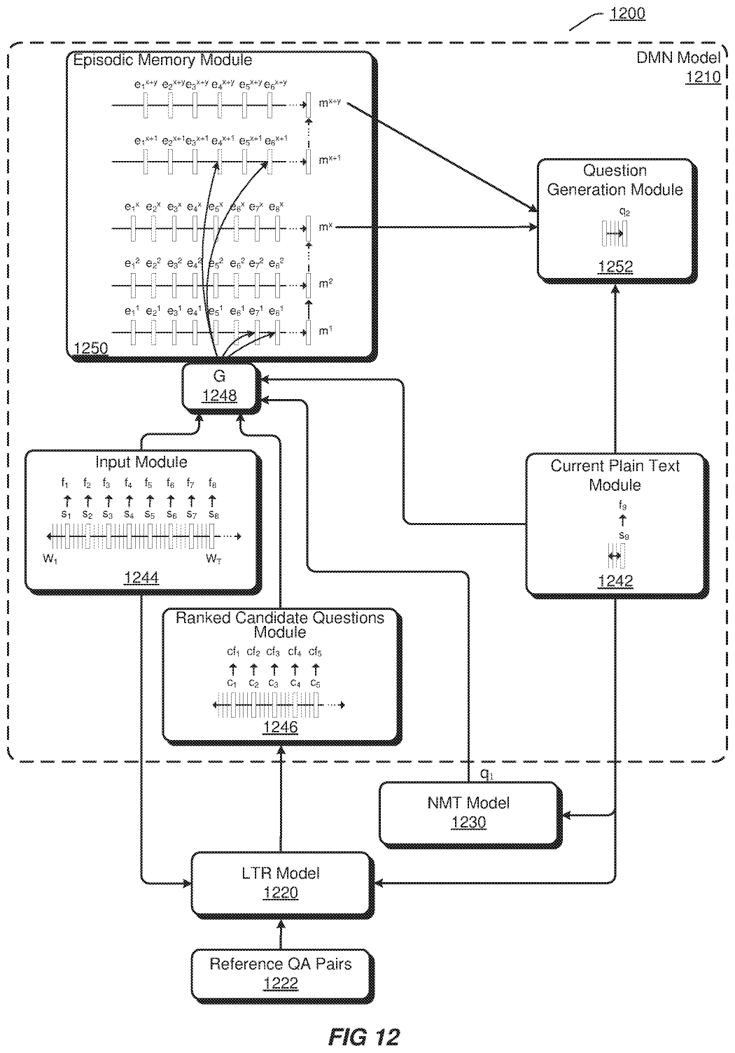

FIG. 12 illustrates an exemplary process 1200 for generating a question through a DMN model according to an embodiment.

As shown in FIG. 12, a DMN model 1210 may be used for generating a question for a plain text. A <question, plain text> pair may be formed based on the generated question and the plain text, and added into a <question, plain text> pair database. Question-plain text pairs in the <question, plain text> pair database may be construed as QA pairs generated through the NMT model 1210 according to the embodiments of the present disclosure. As shown in FIG. 12, the DMN model 1210 may cooperate with a LTR model 1220 and a NMT model 1230 to generate a question. However, it should be appreciated that, in other implementations, either or both of the LTR model 1220 and the NMT model 1230 may be omitted from the process 1200.

The DMN model 1210 may take a plain text and context information of the plain text as inputs, where a question is intended to generate for the plain text, and the context information may refer to one or more plain texts previously input to the DMN model 1210. For example, a plain text S₉ may be input through a current plain text model 1242, and a sequence of sentences S₁ to S₈ in the context information may be input through an input module 1244. The DMN model 1210 may also take one or more ranked candidate questions C₁ to C₅ as inputs, which are determined by the LTR model 1220 based on the plain text S₉ and a set of reference QA pairs 1222. Moreover, the DMN model 1210 may take a priori question q₁ as an input, which is generated by the NMT model 1230 based on the plain text S₉. A generated question q₂ for the plain text S₉ may be output by a question generation module 1252. It should be appreciated that, when training the DMN model 1210, a training question obtained through any existing approaches and/or artificially checking for an input plain text may be set in the question generation module 1252.

Next, exemplary processes in modules of the DMN model 1210 will be discussed in details.

At the input module 1244, a sequence of sentences S₁ to S₈ in the context information may be processed. Each sentence is ended with “</s>” to denote the ending of one sentence. All the eight sentences may be concatenated together to form a word sequence having T words, from W₁ to W_{T}. A bidirectional GRU encoding may be applied on the word sequence. For the left-to-right direction or the right-to-left direction, at each time step t, the DMN model 1210 may update its hidden state as hₜ=GRU(L[wₜ], hₜ₋₁), where L is an embedding matrix, and wₜ is a word index of the t-th word in the word sequence. Thus, a resulting representation vector for a sentence is a combination of two vectors and each vector is from one direction. Internal mechanism of the GRU may follow Equations (7) to (10). These equations may also be abbreviated as hₜ=GRU(xₜ, hₜ₋₁).

In addition to encoding the word sequence, a positional encoding with bidirectional GRU may also be applied so as to represent “facts” of the sentences. The facts may be computed as fₜ=GRUₗ₂ᵣ(L[Sₜ],fₜ₋₁)+GRUᵣ₂ₗ(L[Sₜ], fₜ₋₁), where l2r denotes left-to-right, r2l denotes right-to-left, S, is an embedding expression of a current sentence, and fₜ₋₁, fₜ are facts of a former sentence and the current sentence respectively. As shown in FIG. 12, facts f₁ to f₈ are obtained for the eight sentences in the context information.

At the current plain text module 1242, the encoding for the current plain text S₉ is a simplified version of the input module 1244, where there is only one sentence to be processed in the current plain text module 1242. The processing by the current plain text module 1242 is similar with the input module 1244. Assuming that there are T_{Q} words in the current plain text, hidden states at the time step t may be computed as qₜ=[GRUₗ₂ᵣ(L[Wₜ^{Q}]qₜ₋₁),GRUᵣ₂ₗ(L[Wₜ^{Q}],qₜ₋₁)], where L is an embedding matrix, and Wₜ^{Q} is a word index of the t-th word in the current plain text. A fact f₉ may be obtained for the current plain text S₉ in the current plain text module 1242.

The DMN model 1210 may comprise a ranked candidate questions module 1246. At the ranked candidate questions module 1246, the DMN model 1210 may compute hidden state and facts for one or more ranked candidate questions in the same way as the input module 1244. As an example, FIG. 12 shows five candidate questions C₁ to C₅, and five facts cf₁ to cf₅ are obtained for these candidate questions.

Although not shown, the DMN model 1210 may also compute a fact fₚ for the priori question q₁ generated by the NMT model 1230 in the same way as the current plain text module 1242.

The DMN model 1210 may comprise an attention mechanism module and an episodic memory module. The episodic memory module may include a recurrent network, and the attention mechanism module may be based on a gating function. The attention mechanism module may be separated from or incorporated in the episodic memory module.

According to a conventional computing process, the episodic memory module and the attention mechanism module may cooperate to update episodic memory in an iteration way. For each pass i, the gating function of the attention mechanism module may take a fact fⁱ, a previous memory vector mⁱ⁻¹, and a current plain text S as inputs, to compute an attention gate gₜⁱ=G [fⁱ, mⁱ⁻¹, S]. To compute the episode et for pass i, a GRU over a sequence of inputs. e.g., a list of facts fⁱ, weighted by the gates gⁱ may be applied. Then the episodic memory vector may be computed as mⁱ=GRU(eⁱ, mⁱ⁻¹). Initially, m⁰ is equal to a vector expression of the current plain text S. The episode vector that is given to a question generation module may be the final state m^{x} of the GRU. The following Equation (18) is for updating hidden states of the GRU at a time step t, and the following Equation (19) is for computing the episode.

hₜⁱ=gₜⁱGRU(fₜ,hₜ₋₁ⁱ)+(1−gₜⁱ)hₜ₋₁ⁱ Equation (18)

eⁱ=h_{T}_{_{c}}ⁱ Equation(19)

where T_{c} is the number of input sentences.

According to the embodiment of the present disclosure, the processing in an attention mechanism module 1248 and an episodic memory module 1250 in the DMN model 1210 further takes the ranked candidate questions and the priori question into account. As shown in FIG. 12, besides the input module 1244 and the current plain text module 1242, the attention mechanism module 1248 also obtains inputs from the ranked candidate questions module 1246 and the NMT module 1230. Thus, the attention gate may be computed as gₜⁱ=G [fⁱ, mⁱ⁻¹, S₉, q₁, cfⁱ, m^{x+i-1}], where cfⁱ denotes the facts from the ranked candidate responses, and m^{x+i-1} is a memory vector computed for the ranked candidate questions and the priori question. Accordingly, the recurrent network in the episodic memory module 1250 further comprises a computing process of memories m^{x+1} to m^{x+y} for the ranked candidate questions and the priori question. For example, e₁^{x+i} to e₅^{x+i} in FIG. 12 correspond to the ranked candidate questions, and e₆^{x+i} in FIG. 12 corresponds to the priori question. Outputs from the episodic memory module 1250 to the question generation module 1252 include at least m^{x} and m^{x+y}.

The question generation module 1252 may be used for generating a question. A GRU decoder may be adopted in the question generation module 1252, and an initial state of the GRU decoder may be initialized to be the last memory vector a₀=[m^{x}, m^{x+y}]. At a time step t, the GRU decoder may take the current plain text f₉, a last hidden state aₜ₋₁, and a previous output yₜ₋₁ as inputs, and then compute a current output as:

yₜ=softmax(W^{(a)}aₜ) Equation (20)

where aₜ=GRU([yₜ₋₁, f₉], aₜ₋₁), and W^{(a)} is a weight matrix by training.

The last generated word may be concatenated to the question vector at each time step. The generated output by the question generation module 1252 may be trained with a cross-entropy error classification of a correct sequence attached with a “</s>” tag at the end of the sequence.

The generated question output from the question generation module 1252 may be used for forming a QA pair together with the current plain text.

It should be appreciated that all the modules, equations, parameters and processes discussed above in connection with FIG. 12 are exemplary, and the embodiments of the present disclosure are not limited to any details in the discussion.

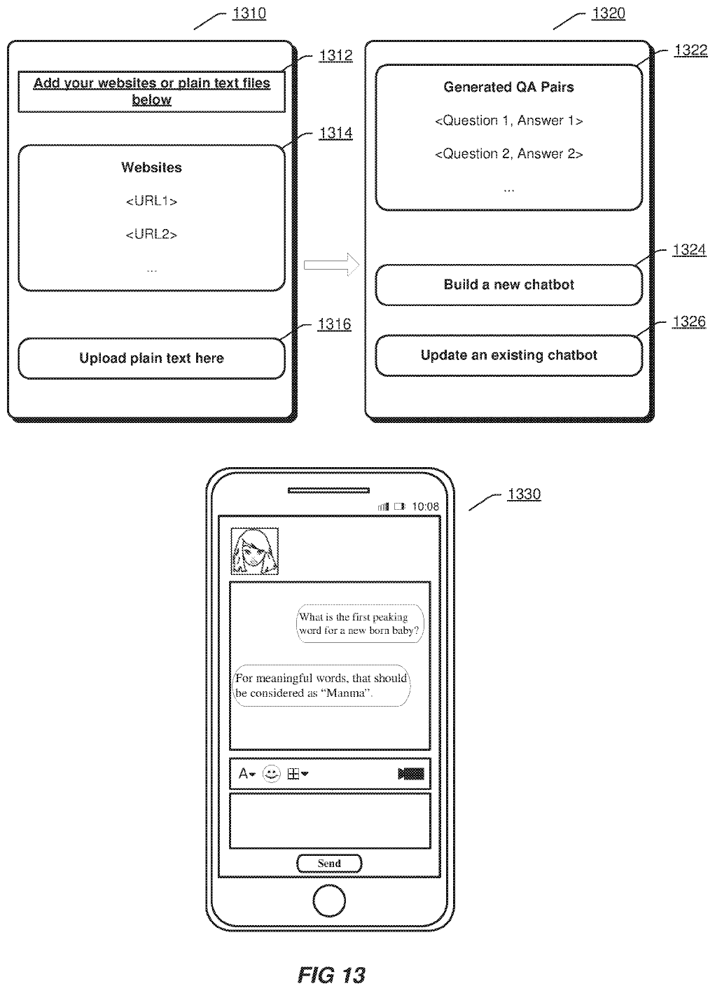

FIG. 13 illustrates exemplary user interfaces according to an embodiment. The user interfaces in FIG. 13 may be shown to a client, e.g., a company requiring a chatbot provision service, when the client is assessing, such as, a corresponding URL. These user interfaces may be used by the client for building a new chatbot or updating an existing chatbot.

As shown in the user interface 1310, block 1312 indicates that this user interface is used for adding websites or plain text files. At block 1314, the client may add, delete or edit URLs of websites. At block 1316, the client may upload a plain text file.

The user interface 1320 is triggered by an operation of the client in the user interface 1310. Block 1322 shows a list of QA pairs generated from plain texts in the websites or the plain text file input by the client. The client may choose to build a new chatbot at block 1324, or update an existing chatbot at block 1326.

The user interface 1330 shows a chat window with a newly-built chatbot or a newly-updated chatbot that is obtained through an operation of the client in the user interface 1320. As shown in the user interface 1330, the chatbot may provide responses based on the generated QA pairs shown in block 1322.

It should be appreciated that the user interfaces in FIG. 13 are exemplary, and the embodiments of the present disclosure are not limited to any forms of user interface.

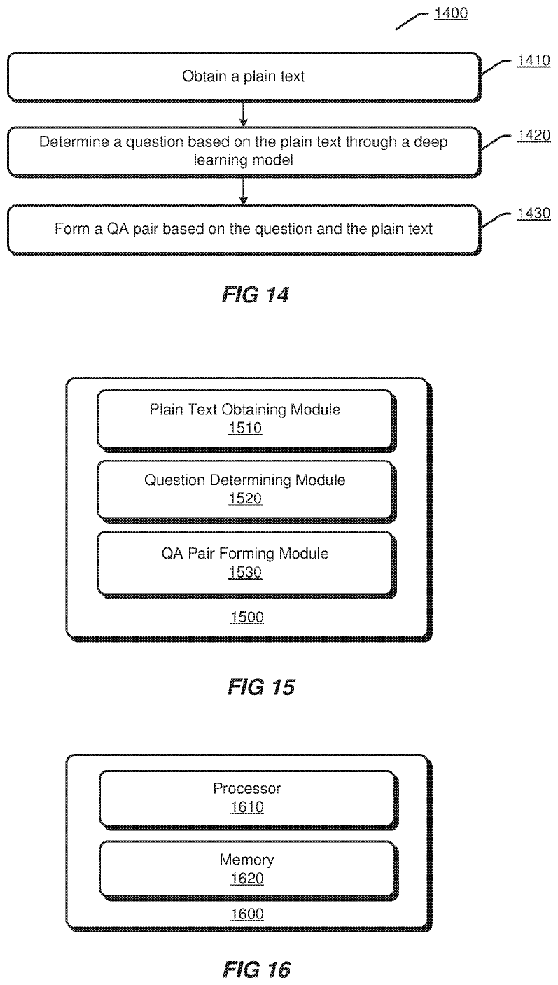

FIG. 14 illustrates a flowchart of an exemplary method 1400 for generating QA pairs for automated chatting according to an embodiment.

At 1410, a plain text may be obtained.

At 1420, a question may be determined based on the plain text through a deep learning model.

At 1430, a QA pair may be formed based on the question and the plain text.

In an implementation, the deep learning model may comprise at least one of a LTR model, a NMT model and a DMN model.

In an implementation, the deep learning model may comprise a LTR model, and the LTR model may be for computing a similarity score between the plain text and a reference QA pair through at least one of word matching and latent semantic matching. In an implementation, the similarity score may be computed through: computing a first matching score between the plain text and a reference question in the reference QA pair; computing a second matching score between the plain text and a reference answer in the reference QA pair; and combining the first matching score and the second matching score to obtain the similarity score. In an implementation, the first matching score and the second matching score may be computed through GBDT.

In an implementation, the determining the question at 1420 may comprise: computing similarity scores of a plurality of reference QA pairs compared to the plain text through the LTR model; and selecting a reference question in an reference QA pair having the highest similarity score as the question.

In an implementation, the deep learning model may comprise a NMT model, and the NMT model may be for generating the question based on the plain text in a sequence-to-sequence approach, the plain text being as an input sequence, the question being as an output sequence. In an implementation, the NMT model may comprise an attention mechanism for determining a pattern of the question. In an implementation, the NMT model may comprise at least one of: a first recurrent process for obtaining context information for each word in the input sequence; and a second recurrent process for obtaining context information for each word in the output sequence.

In an implementation, the deep learning model may comprise a DMN model, and the DMN model may be for generating the question based on the plain text through capturing latent semantic relations in the plain text.

In an implementation, the deep learning model may comprise a LTR model, and the DMN model may comprise an attention mechanism, the attention mechanism taking at least one candidate question as an input, the at least one candidate question being determined by the LTR model based on the plain text.

In an implementation, the deep learning model may comprise a NMT model, and the DMN model may comprise an attention mechanism, the attention mechanism taking a reference question as an input, the reference question being determined by the NMT model based on the plain text.

In an implementation, the deep learning model may comprise at least one of a LTR model and a NMT model, and the DMN model may compute memory vectors based at least on: at least one candidate question and/or a reference question, the at least one candidate question being determined by the LTR model based on the plain text, the reference question being determined by the NMT model based on the plain text.

It should be appreciated that the method 1400 may further comprise any steps/processes for generating QA pairs for automated chatting according to the embodiments of the present disclosure as mentioned above.

FIG. 15 illustrates an exemplary apparatus 1500 for generating QA pairs for automated chatting according to an embodiment.

The apparatus 1500 may comprise: a plain text obtaining module 1510, for obtaining a plain text; a question determining module 1520, for determining a question based on the plain text through a deep learning model; and a QA pair forming module 1530, for forming a QA pair based on the question and the plain text.

In an implementation, the deep learning model may comprise at least one of a LTR model, a NMT model and a DMN model.

In an implementation, the deep learning model may comprise a LTR model, and the LTR model may be for computing a similarity score between the plain text and a reference QA pair through at least one of word matching and latent semantic matching. In an implementation, the similarity score may be computed through: computing a first matching score between the plain text and a reference question in the reference QA pair, computing a second matching score between the plain text and a reference answer in the reference QA pair; and combining the first matching score and the second matching score to obtain the similarity score.

In an implementation, the deep learning model may comprise a NMT model, and the NMT model may be for generating the question based on the plain text in a sequence-to-sequence approach, the plain text being as an input sequence, the question being as an output sequence. In an implementation, the NMT model may comprise at least one of: a first recurrent process for obtaining context information for each word in the input sequence; and a second recurrent process for obtaining context information for each word in the output sequence.

In an implementation, the deep learning model may comprise a DMN model, and the DMN model may be for generating the question based on the plain text through capturing latent semantic relations in the plain text. In an implementation, the deep learning model may comprise at least one of a LTR model and a NMT model, and the DMN model may comprise an attention mechanism, the attention mechanism taking at least one candidate question and/or a reference question as an input, the at least one candidate question being determined by the LTR model based on the plain text, the reference question being determined by the NMT model based on the plain text. In an implementation, the deep learning model may comprise at least one of a LTR model and a NMT model, and the DMN model may compute memory vectors based at least on: at least one candidate question and/or a reference question, the at least one candidate question being determined by the LTR model based on the plain text, the reference question being determined by the NMT model based on the plain text.

Moreover, the apparatus 1500 may also comprise any other modules configured for performing any operations of the methods for generating QA pairs for automated chatting according to the embodiments of the present disclosure as mentioned above.

FIG. 16 illustrates an exemplary apparatus 1600 for generating QA pairs for automated chatting according to an embodiment.

The apparatus 1600 may comprise at least one processor 1610. The apparatus 1600 may further comprise a memory 1620 that is connected with the processor 1110. The memory 1620 may store computer-executable instructions that, when executed, cause the processor 1610 to perform any operations of the methods for generating QA pairs for automated chatting according to the embodiments of the present disclosure as mentioned above.

The embodiments of the present disclosure may be embodied in a non-transitory computer-readable medium. The non-transitory computer-readable medium may comprise instructions that, when executed, cause one or more processors to perform any operations of the methods for generating QA pairs for automated chatting according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors (e.g., cache or register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

What is claimed is:

1. A method for generating question-answer (QA) pairs for automated chatting, comprising:
obtaining a plain text;
determining a question based on the plain text through a deep learning model; and
forming a QA pair based on the question and the plain text.

2. The method of claim 1, wherein
the deep learning model comprises a Learning-to-Rank (LTR) model, and
the LTR model is for computing a similarity score between the plain text and a reference QA pair through at least one of word matching and latent semantic matching.

3. The method of claim 2, wherein the similarity score is computed through:
computing a first matching score between the plain text and a reference question in the reference QA pair,
computing a second matching score between the plain text and a reference answer in the reference QA pair; and
combining the first matching score and the second matching score to obtain the similarity score.

4. The method of claim 3, wherein the first matching score and the second matching score are computed through Gradient Boosting Decision Tree (GBDT).

5. The method of claim 1, wherein the deep learning model comprises a Learning-to-Rank (LTR) model, and the determining the question comprises:
computing similarity scores of a plurality of reference QA pairs compared to the plain text through the LTR model; and
selecting a reference question in an reference QA pair having the highest similarity score as the question.

6. The method of claim 1, wherein
the deep learning model comprises a Neutral Machine Translation (NMT) model, and
the NMT model is for generating the question based on the plain text in a sequence-to-sequence approach, the plain text being as an input sequence, the question being as an output sequence.

7. The method of claim 6, wherein the NMT model comprises an attention mechanism for determining a pattern of the question.

8. The method of claim 6, wherein the NMT model comprises at least one of:
a first recurrent process for obtaining context information for each word in the input sequence; and
a second recurrent process for obtaining context information for each word in the output sequence.

9. The method of claim 1, wherein
the deep learning model comprises a Dynamic Memory Network (DMN) model, and
the DMN model is for generating the question based on the plain text through capturing latent semantic relations in the plain text.

10. The method of claim 9, wherein
the deep learning model comprises a Learning-to-Rank (LTR) model, and
the DMN model comprises an attention mechanism, the attention mechanism taking at least one candidate question as an input, the at least one candidate question being determined by the LTR model based on the plain text.

11. The method of claim 9, wherein
the deep learning model comprises a Neutral Machine Translation (NMT) model, and
the DMN model comprises an attention mechanism, the attention mechanism taking a reference question as an input, the reference question being determined by the NMT model based on the plain text.

12. The method of claim 9, wherein
the deep learning model comprises a Learning-to-Rank (LTR) model and a Neutral Machine Translation (NMT) model, and
the DMN model computes memory vectors based at least on: at least one candidate question and/or a reference question, the at least one candidate question being determined by the LTR model based on the plain text, the reference question being determined by the NMT model based on the plain text.

13. An apparatus for generating question-answer (QA) pairs for automated chatting, comprising:
a plain text obtaining module, for obtaining a plain text;
a question determining module, for determining a question based on the plain text through a deep learning model; and
a QA pair forming module, for forming a QA pair based on the question and the plain text.

14. The apparatus of claim 13, wherein
the deep learning model comprises a Learning-to-Rank (LTR) model, and
the LTR model is for computing a similarity score between the plain text and a reference QA pair through at least one of word matching and latent semantic matching.

15. The apparatus of claim 14, wherein the similarity score is computed through:
computing a first matching score between the plain text and a reference question in the reference QA pair,
computing a second matching score between the plain text and a reference answer in the reference QA pair; and
combining the first matching score and the second matching score to obtain the similarity score.

16. The apparatus of claim 13, wherein
the deep learning model comprises a Neutral Machine Translation (NMT) model, and
the NMT model is for generating the question based on the plain text in a sequence-to-sequence approach, the plain text being as an input sequence, the question being as an output sequence.

17. The apparatus of claim 16, wherein the NMT model comprises at least one of:
a first recurrent process for obtaining context information for each word in the input sequence; and
a second recurrent process for obtaining context information for each word in the output sequence.

18. The apparatus of claim 13, wherein
the deep learning model comprises a Dynamic Memory Network (DMN) model, and
the DMN model is for generating the question based on the plain text through capturing latent semantic relations in the plain text.

19. The apparatus of claim 18, wherein
the deep learning model comprises at least one of a Learning-to-Rank (LTR) model and a Neutral Machine Translation (NMT) model, and
the DMN model comprises an attention mechanism, the attention mechanism taking at least one candidate question and/or a reference question as an input, the at least one candidate question being determined by the LTR model based on the plain text, the reference question being determined by the NMT model based on the plain text.

20. The apparatus of claim 18, wherein
the deep learning model comprises at least one of a Learning-to-Rank (LTR) model and a Neutral Machine Translation (NMT) model, and
the DMN model computes memory vectors based at least on: at least one candidate question and/or a reference question, the at least one candidate question being determined by the LTR model based on the plain text, the reference question being determined by the NMT model based on the plain text.
